(19) United States
(12) Patent Application Publication
(10) Pub. No.: US 2007/0004430 A1
(43) Pub. Date: Jan. 4, 2007

(54) Position measuring system and method using wireless broadband (WIBRO) signal

(75) Inventors: Moon-Pil Hyun, Suwon-si (KR); Hee Jung, Ansan-si (KR); Jin-Won Kim, Seoul (KR); Hyun-Su Hong, Seongnam-si (KR); Jang-Gyu Lee, Seoul (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); Seoul National University Industry Foundation, Seoul (KR)

(21) Appl. No.: 11/481,071

(22) Filed: Jul. 5, 2006

(30) Foreign Application Priority Data
Jul. 4, 2005 (KR) 10-2005-0059931
Apr. 18, 2006 (KR) 2006-35152

(51) Int. Cl. H04Q 7/20

(52) U.S. Cl. 455/456.1

(57) ABSTRACT

Provided is a position measuring system and method using a Wireless Broadband (WiBro) signal. The position measuring system measures the position of a terminal using relative delay information that is a parameter of the WiBro signal, used for a hand-over. Since the position of a terminal is measured using a parameter for a hand-over, additional data measurement is not required for the position measurement. Furthermore, efficiency in the use of a parameter of a WiBro system can be improved by using a parameter used only in the hand-over for position measurement.

This application claims priority under 35 U.S.C. §119 to an application entitled “Position Measuring System and Method Using WiBro Signal” filed in the Korean Intellectual Property Office on Jul. 4, 2005 and Apr. 18, 2006 and assigned Serial Nos. 2005-59931 and 2006-35152, respectively, the contents of which are incorporated herein by reference.

### BACKGROUND OF THE INVENTION

1. Field of the Invention

The present invention generally relates to a Wireless Broadband (WiBro) system, and in particular, to a system and method for measuring the position of a terminal in a WiBro system.

2. Description of the Related Art

Generally, when a mobile station moves from a cell of a serving base station (or sector) to a cell of a target base station (or sector), a mobile communication system performs a hand-over (or hand-off) in which a communication path is switched to the cell of the target base station using a specific signal to continue communication.

For example, in a Code Division Multiple Access (CDMA) system, a range between a base station and a terminal is calculated using a Round Trip Delay (RTD) signal transmitted from the base station to the terminal and a hand-over to a base station that is nearest to the terminal is performed. This method is based on the fact that in a context where all base stations operate with the same absolute time, if it takes time t for a signal from a base station to arrive in a terminal, it also takes time t for the terminal to send a signal to the base station (communication paths for transmission/reception are the same) and thus a signal delay between the terminal and the base station is 2 t.

The RTD is based on the distance between the base station and the terminal. Thus, the RTD can be used for not only a hand-over but also measurement of the position of the terminal. However, to measure the position of the terminal using the RTD, a single base station needs to measure RTDs for at least three terminals, or at least three base stations needs to simultaneously receive a signal from a single terminal.

Thus, in terminal position measurement using the RTD, a clock error between terminals may occur and a base station needs to then have a new positioning algorithm. As a result, the current CDMA system has difficulty in measuring the position of a terminal using the RTD.

In a Wireless Broadband (WiBro) system, a hand-over between a base station and a terminal is performed using relative delay information. The relative delay information is used only as a parameter for synchronizing the terminal with a new base station during the hand-over.

### SUMMARY OF THE INVENTION

The relative delay information is also based on the distance between the terminal and the base station but is not used for measurement of the position of the terminal. Thus, the relative delay may be used for calculation of the position of the terminal.

If the relative delay information is used, the position of the terminal would be more easily measured because it is not necessary for a single base station to measure RTDs for at least three terminals, or for at least three base stations to simultaneously receive a signal from a single terminal.

It is, therefore, an object of the present invention to provide a system and method for measuring the position of a terminal using a hand-over parameter of a WiBro signal.

It is another object of the present invention to provide a system and method for measuring the position of a terminal using relative delay information of a WiBro signal.

According to one aspect of the present invention, there is provided a position measuring system using a WiBro signal. The position measuring system includes a main base station for providing information about neighboring base stations and transmitting a neighboring base station scan result from a terminal, the terminal for receiving the information about the neighboring base stations, scanning the neighboring base stations in response to a position measurement request, and transmitting the neighboring base station scan result, and a Position Determination Entity (PDE) for measuring the position of the terminal using relative delay information between the main base station and the neighboring base stations, which is included in the neighboring base station scan result, and base station position information.

According to another aspect of the present invention, there is provided a position measuring system using a WiBro signal. The position measuring system includes a PDE for providing base station position information, a main base station for providing information about neighboring base stations, and a terminal for scanning the neighboring base stations in response to a position measurement request, measuring relative delay information between the main base station and the neighboring base stations, and measuring its position using the relative delay information and the base station position information provided from the PDE.

According to further another aspect of the present invention, there is provided a position measuring method using a WiBro signal. The position measuring method includes a main base station providing to a terminal information about neighboring base stations, the terminal scanning the neighboring base stations and transmitting a neighboring base station scan result to a PDE, and a PDE measuring the position of the terminal using relative delay information between the main base station and the neighboring base stations, which is included in the neighboring base station scan result, and previously stored base station position information.

According to still another aspect of the present invention, there is provided a position measuring method using a WiBro signal. The position measuring method includes a main base station providing to a terminal information about neighboring base stations, the terminal scanning the neighboring base stations and transmitting a neighboring base station scan result to a PDE, and a PDE measuring the position of the terminal using relative delay information between the main base station and the neighboring base stations, which is included in the neighboring base station scan result, and previously stored base station position information.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a MOB_SCN_REPORT message in a WiBro system;

FIG. 2 is a diagram used to illustrate relative delay information according to the present invention;

FIG. 3 illustrates a position measuring system using relative delay information according to the present invention;

FIG. 4 is a flowchart illustrating a position measuring method using relative delay information according to a first embodiment of the present invention;

FIG. 5 is a flowchart illustrating a position measuring method using relative delay information according to a second embodiment of the present invention;

FIG. 6 is a flowchart illustrating a position measuring method using relative delay information according to a third embodiment of the present invention;

FIG. 7 is a flowchart illustrating a position measuring method using relative delay information according to a fourth embodiment of the present invention;

FIG. 8 is a flowchart illustrating a position measuring method using relative delay information according to a fifth embodiment of the present invention;

FIG. 9 illustrates the structure of a MOB_NBR_ADV message according to the present invention;

FIG. 10 illustrates the structure of a MOB_SCN_REQ message according to the present invention;

FIG. 11 illustrates the structure of a MOB_SCN_RSP message according to the present invention;

FIG. 12 illustrates the structure of a MOB_SCN_REPORT message according to the present invention;

FIG. 13 is a flowchart illustrating a position measuring method using relative delay information according to a sixth embodiment of the present invention;

FIG. 14 is a flowchart illustrating a position measuring method using relative delay information according to a seventh embodiment of the present invention;

FIG. 15 is a flowchart illustrating a position measuring method using relative delay information according to an eighth embodiment of the present invention;

FIG. 16 is a flowchart illustrating a position measuring method using relative delay information according to a ninth embodiment of the present invention; and

FIG. 17 is a flowchart illustrating a position measuring method using relative delay information according to a tenth embodiment of the present invention.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

A position measuring system according to the present invention measures the position of a terminal using relative delay information that is a hand-over parameter of a WiBro signal.

In a WiBro system, in a hand-over, a terminal receives neighboring base station information from a main base station, scans its neighboring base stations if it is determined that it is necessary to do so, and transmits the scan result to the main base station through a MOB_SCN_REPORT message that includes the scan result.

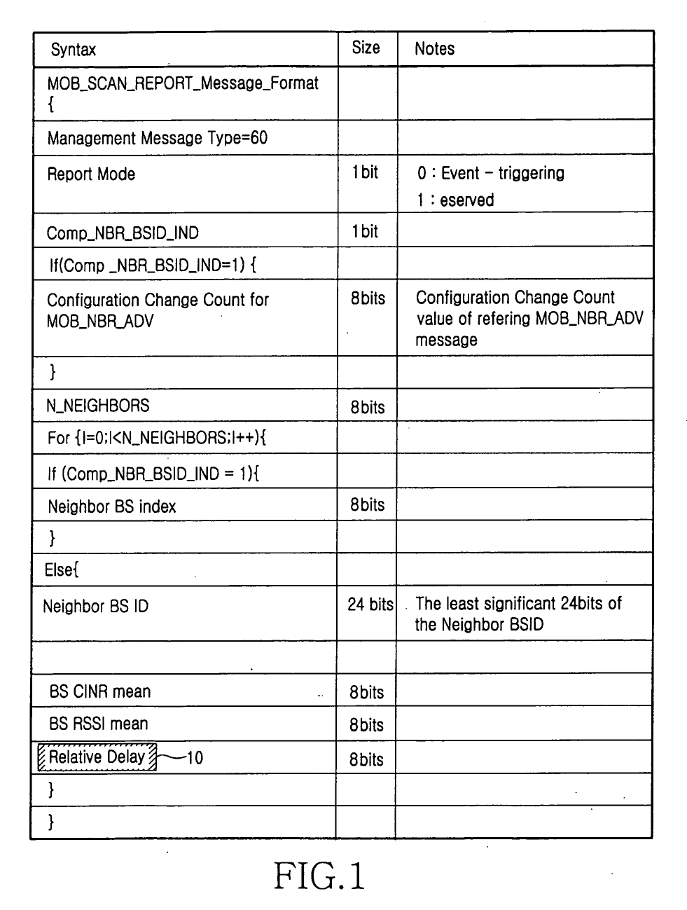

FIG. 1 illustrates the MOB_SCN_REPORT message in the WiBro system. Referring to FIG. 1, the MOB_SCN_REPORT message includes parameters such as Neighbor BS ID, BS CINR mean, BS RSSI mean, and Relative Delay as part of the scan result. Theses parameters are used during a hand-over.

In particular, Relative Delay 10 indicates the relative delay of a downlink signal transmitted from a neighboring base station of a terminal with respect to a downlink signal transmitted from a main base station. In other words, the Relative Delay 10 implies a difference between the time required for the downlink signal of the main base station to arrive in the terminal and the time required for the downlink signal from the neighboring base station to arrive in the terminal.

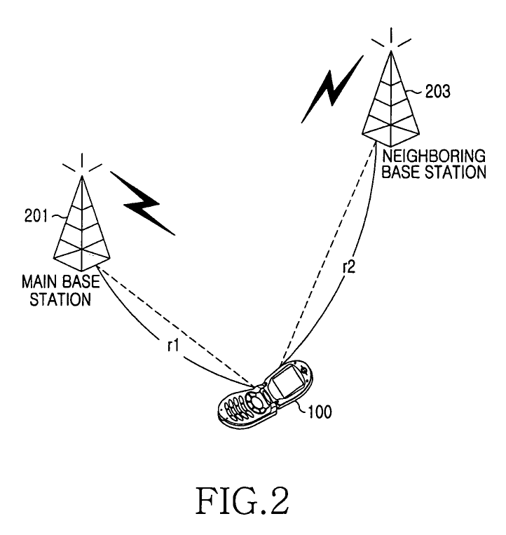

FIG. 2 is a diagram used to illustrate relative delay information according to the present invention.

Referring to FIG. 2, a terminal 100 receives downlink signals from a main base station 201 and a neighboring base station 203. Since a distance r1 between the terminal 100 and the main base station 201 and a distance r2 between the terminal 100 and the neighboring base station 203 are different from each other, the two downlink signals received by the terminal 100 has a signal delay difference corresponding to a distance difference of (r2−r1). Information about the signal delay difference between the main base station 201 and the neighboring base station 203 is the relative delay information.

Thus, the distance difference (r2−r1) can be acquired using the relative delay information.

Therefore, a position measuring system according to the present invention calculates the distance difference, i.e., a difference between a distance between a main base station and a terminal and a distance between a neighboring base station and the terminal, using the relative delay information and measures the position of the terminal using the calculated distance difference.

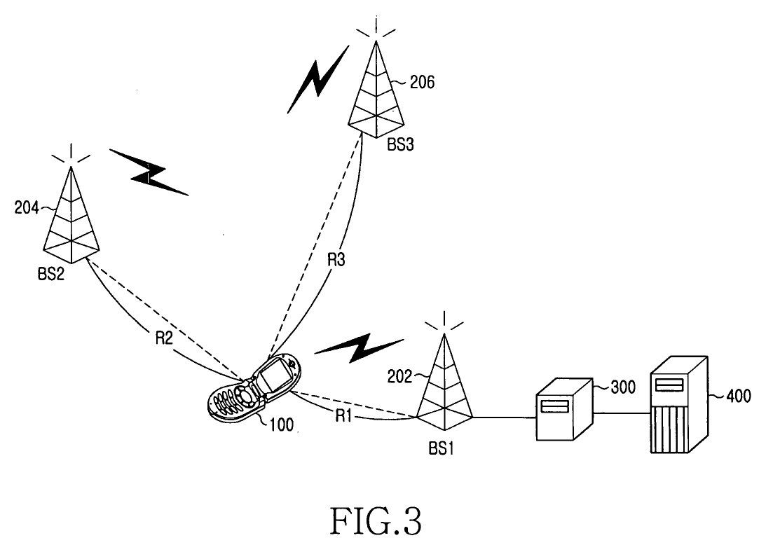

FIG. 3 illustrates a position measuring system using relative delay information according to the present invention. Referring to FIG. 3, the position measuring system includes a terminal 100, a main base station (BS1) 202, neighboring base stations (BS2 and BS3) 204 and 206, a control station 300, and a Position Determination Entity (PDE) 400.

The main base station 202 communicates with the terminal 100 and provides information about the neighboring base stations 204 and 206. The terminal 100 determines whether it is necessary to scan the neighboring base stations 204 and 206 in response to a position measurement request. If it is necessary to scan the neighboring base stations 204 and 206, the terminal 100 transmits to the communicating main base station 202 a request for information required to scan the neighboring base stations 204 and 206, receives the information from the main base station 202, and scans the neighboring base stations 204 and 206. The information required for the scan includes the time required to scan the neighboring base stations 204 and 206, the number of scan operations, and a scan result reporting mode.

After scanning the neighboring base stations 204 and 206, the terminal 100 transmits the scan result to the main base station 202. The scan result includes relative delay information indicating a difference between time T₀ required for a downlink signal of the main base station 202 to arrive in the terminal 100 and time T₁ required for a downlink signal from the neighboring base station 204 to arrive in the terminal 100, a difference between time T₀ and time T₂ required for a downlink signal from the neighboring base station 206 to arrive in the terminal 100, and base station ID information.

The main base station 202 transmits to the control station 300 the scan result from the terminal 100.

The control station 300 delivers the received scan result to the PDE 400.

Upon receipt of the scan result from the control station 300, the PDE 400 extracts the relative delay information and the base station ID information from the received scan result and measures the position of the terminal 100 using the relative delay information and the position information of the base stations 202, 204, and 206 corresponding to the base station ID information.

Referring to FIG. 3, the PDE 400 calculates a distance difference of (R1−R2) between the distance R1 between the main base station 202 and the terminal 100 and the distance R2 between the neighboring base station 204 and the terminal 100, and a distance difference of (R1−R3) between the distance R1 and the distance R3 between the neighboring base station 206 and the terminal 100, each using the relative delay information. The PDE 400 may calculate the position of the terminal 100 using a trigonometric measurement method with the relative delay information and the position information of the base stations 202, 204, and 206 corresponding to the base station ID information. The PDE 400 requires at least two pieces of relative delay information to measure the position of the terminal 100. Although the PDE 400 may calculate the position of the terminal 100 and transmit the calculated position to the terminal 100 as described above, the terminal 100 may measure its position using relative delay information through a position measurement application implemented therein.

As mentioned above, since the position measuring system according to the present invention measures the position of the terminal using relative delay information used in a hand-over, it does not require additional data measurement for positioning and can use a parameter that helps the hand-over for position measurement.

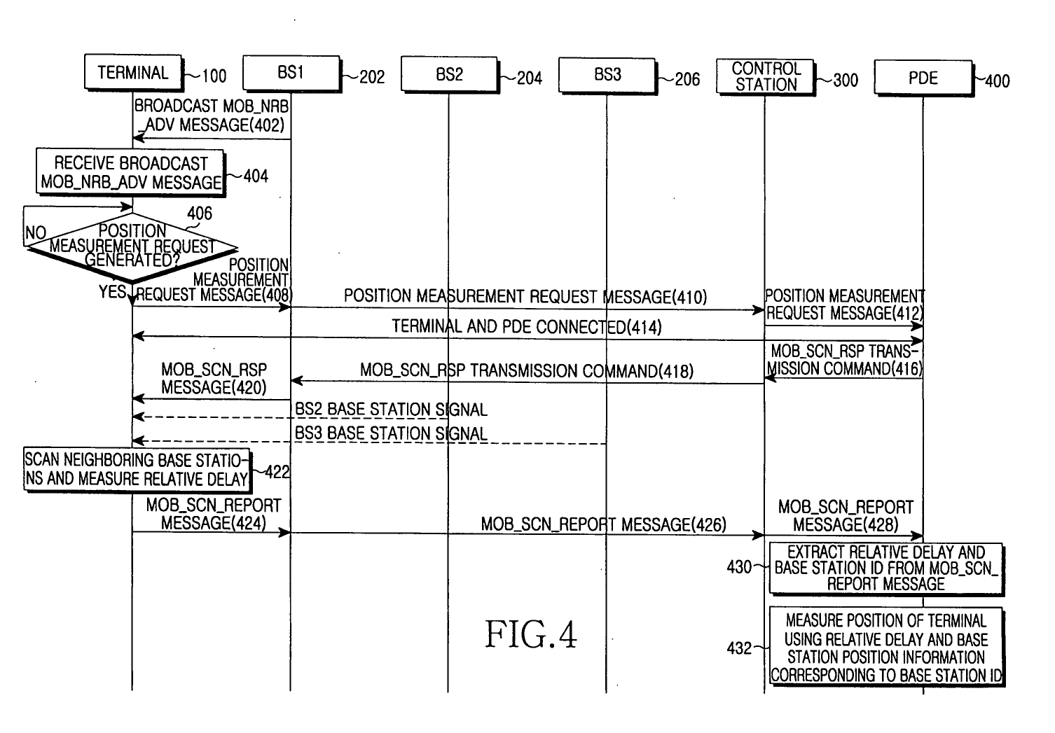

FIG. 4 is a flowchart illustrating a position measuring method using relative delay information according to a first embodiment of the present invention. In FIG. 4, the terminal 100 requests position measurement and, when a WiBro network is used, a position measurement request from the terminal 100 and a neighboring base station scan result are delivered to the PDE 400 through the main base station (BS1) 202 and the control station 300. The main base station (BS1) 202 broadcasts a MOB_NBR_ADV message including information about its neighboring base stations (BS2 and BS3) 204 and 206 in step 402. The MOB_NBR_ADV message may be used when a position measurement request is generated by a need to measure the position of the terminal 100 or a need for the main base station 202 to secure a measurement value required for measuring the position of the terminal 100.

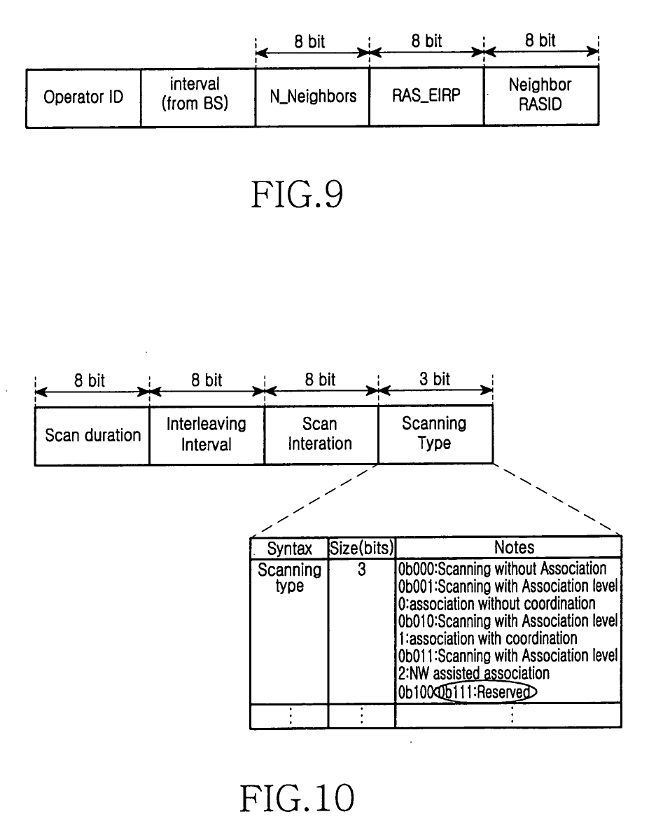

FIG. 9 illustrates the structure of the MOB_NBR_ADV message according to the present invention. Referring to FIG. 9, the MOB_NBR_ADV message includes parameters such as Operator ID, interval (from BS), N_Neighbors, RAS_EIRP, and Neighbor RASID.

Operator ID is a unique network ID used in a cell in which the terminal 100 is registered.

Interval (from BS) is the broadcasting interval of the MOB_NBR_ADV message, i.e., the transmission time interval of the MOB_NRB_ADV message in a Base Station (BS). The transmission time interval of the MOB_NRB_ADV message in the BS is up to 1 second.

N_Neighbors, composed of 8 bits, is a value combining a Base Station Identification (BSID), a preamble index, and a Downlink Channel Descriptor (DCD) of a neighboring base station.

Remote Access Server (RAS)_EIRP, composed of 8 bits, is an Effective Isotropic Radiated Power (EIRP) of a neighboring base station and has an integer value ranging between 128 dBm and +127 dBm. When a BS EIRP indicator bit is set to 0 in PHY Profile ID, the EIRP of a neighboring base station is the same as the EIRP of a main base station.

Neighbor RASID is an RAS ID parameter of least significant 24 bits included in a DL-MAP message for a neighboring base station. The Neighbor RASID field is provided only when the first bit of Skip-Optional-Field is 0.

As illustrated in FIG. 9, the MOB_NBR_ADV message includes basic information required for the terminal 100 to scan its neighboring base stations, such as the IDs and number of the neighboring base stations.

Returning again to FIG. 4, the terminal 100 receives the MOB_NBR_ADV message from the main base station 202 in step 404. The terminal 100 can acquire information about its neighboring base stations 204 and 206 from the received MOB_NBR_ADV message.

After receipt of the MOB_NBR_ADV message, the terminal 100 determines if a position measurement request is generated in step 406. The position measurement request may be generated by a need for the terminal 100 to check its position or a need for the main base station 202 to measure the position of the terminal 100. Although the terminal 100 may transmit a position measurement request message after receipt of the MOB_NBR_ADV message as mentioned above, it may also receive the MOB_NBR_ADV message after transmitting the position measurement request message. In other words, the receipt of the MOB_NBR_ADV message may precede or follow the transmission of the position measurement request message.

If the position measurement request is generated, the terminal 100 transmits a position measurement request (MOB_SCN_REQ) message to the main base station 202 in step 408. At this time, the position measurement request message is an MOB_SCN_REQ message for requesting scanning of the neighboring base stations 204 and 206, and the terminal 100 changes a field value of the MOB_SCN_REQ message to indicate that the MOB_SCN_REQ message is not intended for a hand-over, but is intended for position measurement, and transmits the MOB_SCN_REQ message to the main base station 202. For example, the terminal 100 may change code values of a scanning type field into ‘0b111’ to indicate that the MOB_SCN_REQ message is intended for a position measurement.

FIG. 10 illustrates the structure of the MOB_SCN_REQ message according to the present invention. Referring to FIG. 10, the MOB_SCN_REQ message includes parameters such as Scan duration, Interleaving Interval, Scan Iteration, and Scanning type.

Scan duration, composed of 8 bits, indicates a scan period requested by the terminal 100. The scan period may be requested in frame units.

Interleaving Interval indicates a time interval between actual scan periods, which is required for a general communication process between the terminal 100 and the main base station 202.

Scan Iteration indicates the number of scan operations performed by the terminal 100.

In Scanning type, code values required for a hand-over are set as indicated by A. In an embodiment of the present invention, using reserved code values, the code values of Scanning type are changed to those for indicating that the MOB_SCN_REQ message is intended for a position measurement. Although the code values of Scanning type are changed in an embodiment of the present invention, code values of any other field that allows the use of reserved code values may be used.

Returning again to FIG. 4, the main base station 202 transmits the MOB_SCN_REQ message to the control station 300 in step 410. The control station 300 transmits the position measurement request message to the PDE 400 in step 412.

Upon receipt of the position measurement request message from the terminal 100 through the control station 300, the PDE 400 connects to the terminal 100 through the control station 300 in step 414.

The PDE 400 transmits a MOB_MSPOS_REQ message transmission command to the control station 300 in step 416. The MOB_MSPOS_REQ message transmission command is a command for requesting the main base station 202 to transmit an MOB_SCN_RSP message including information for scanning the neighboring base stations 204 and 206 to the terminal 100.

The control station 300 receives the MOB_MSPOS_REQ message transmission command and transmits the received MOB_MSPOS_REQ message transmission command to the main base station 202 in step 418.

The main base station 202 then transmits the MOB_SCN RSP message to the terminal 100 in step 420. The main base station 202 transmits the MOB_SCN_RSP message to the terminal 100 after changing a specific field of the MOB_SCN_RSP message to indicate that the MOB_SCN_RSP message is intended for position measurement. For example, the main base station 202 changes the code value of Scanning type of the MOB_SCN_RSP message to ‘0b111’. A reserved code value of another specific field may also be used to indicate that the MOB_SCN_RSP message is intended for position measurement.

The MOB_SCN_RSP message may be directly transmitted from the main base station 202 to the terminal 100 without a need for the MOB_SCN_RSP transmission command from the PDE 400 or the control station 300.

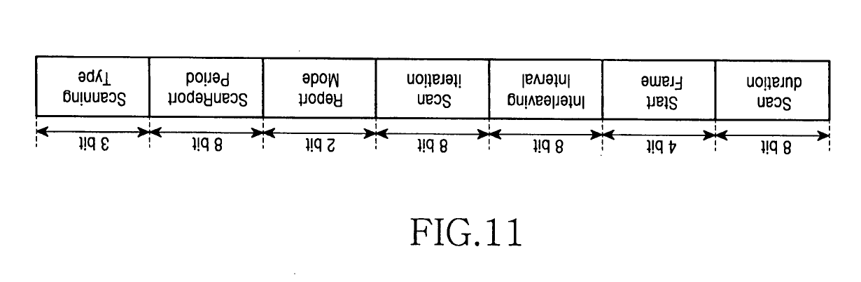

The MOB_SCN_RSP message includes information from the MOB_NBR_ADV message, which is required for scanning neighboring base stations, such as time required for a scan operation, the number of scan operations, and a scan result reporting mode. FIG. 11 illustrates the structure of the MOB_SCN_RSP message according to the present invention. Referring to FIG. 11, the MOB_SCN_RSP message includes parameters such as Scan duration, Start Frame, Interleaving Interval, Scan iteration, Report Mode, Scan Report Period, and Scanning type.

Scan duration, composed of 8 bits, is a parameter indicating a period assigned by the main base station 202 in order for the terminal 100 to scan or associate available neighboring base stations.

Start Frame, composed of 4 bits, is measured from a corresponding frame when the MOB_SCN_RSP message is received. When Start Frame is set to 0, it means that the first scan period of a next frame begins.

Interleaving Interval, composed of 8 bits, indicates an interval between scan operations when the terminal 100 operates normally.

Scan iteration, composed of 8 bits, indicates the number of intervals between scan operations.

Report Mode, composed of 2 bits, indicates a method for reporting a Carrier to Interference and Noise Ratio (CINR) of a neighboring base station measured during a scan period. When Report Mode is 00, it indicates a mode where the terminal 100 merely measures the channel quality of a neighboring Remote Access Server (RAS) without reporting. When Report Mode is 01, it indicates a mode where the terminal 100 reports a channel quality measurement result to the main base station 202 during a scan report period. When Report Mode is 10, it indicates a mode where the terminal 100 reports the channel quality measurement result to the main base station 202 at every channel quality measurement. Report Mode 11 is a reserved mode.

Scan Report Period, composed of 8 bits, indicates a period during which the terminal 100 reports the channel quality measurement result to the main base station 202.

Scanning type, composed of 3 bits, has code values for indicating that the MOB_SCN_RSP message is intended for position measurement.

Returning again to FIG. 4, upon receipt of the MOB_SCN_RSP message, the terminal 100 in step 422 scans the neighboring base stations 204 and 206 using the MOB_NBR_ADV message and the MOB_SCN_RSP Message and measures relative delay information for the neighboring base stations 204 and 206 according to the scan result. For example, the terminal 100 scans the neighboring base stations 204 and 206 by receiving a BS2 base station signal from the neighboring base station 204 and a BS3 base station signal from the neighboring base stations 206 according to the information included in the MOB_SCN_RSP message and measures the relative delay information for the neighboring base stations 204 and 206 according to the scan result.

The terminal 100 encapsulates the scan result in an MOB_SCN_REPORT message and transmits the MOB_SCN_REPORT message to the main base station 202 in step 424. The MOB_SCN_REPORT message includes the relative delay information indicating differences in signal arrival between the terminal 100 and its neighboring base stations 204 and 206.

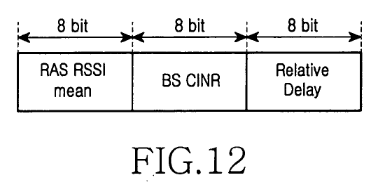

FIG. 12 illustrates the structure of the MOB_SCN_REPORT message according to the present invention. Referring to FIG. 12, the MOB_SCN_REPORT message includes parameters such as RAS RSSI mean, BS CINR, and Relative Delay.

RAS RSSI mean, composed of 8 bits, indicates a Received Signal Strength Indication of a specific base station. RAS RSSI mean is expressed in 0.5 dB units and a result of subtracting 40 dBm from RAS RSSI mean is the actual signal strength. For example, if RAS RSSI mean is 0xff, it indicates −104 dBm and the terminal 100 reports a value ranging between −100 dBm and −40 dBm. RSSI measurement is performed with respect to a preamble and RAS RSSI mean is acquired by averaging measured RSSIs during a specific period.

BS CINR indicates a CINR received in a terminal from a specific base station. CINR indicates a Carrier to Interference and Noise Ratio (CINR) from a base station. BS CINR is expressed in 0.5 dB units and is interpreted as a byte having a sign. CINR measurement is performed with respect to a preamble and BS CINR is acquired by averaging measured CINRs during a specific period.

Relative Delay, composed of 8 bits, indicates a relative delay between downlink signals of the main base station 202 and the neighboring bas stations 204 and 206.

Returning again to FIG. 4, the control station 300 transmits the received MOB_SCN_REPORT message to the PDE 400 in step 428.

The PDE 400 extracts the relative delay information for the neighboring base stations 204 and 206 and the base station ID information from the MOB_SCN_REPORT message received from the control station 300 in step 430 and measures the position of the terminal 100 using the relative delay information and position information of the base stations 202, 204, and 206 corresponding to the base station ID information in step 432. In other words, the PDE 400 acquires a difference between a distance between the terminal 100 and the neighboring base station 204, and a distance between the terminal 100 and the neighboring base station 206, using the relative delay information, and measures the position of the terminal 100 using a trigonometric measurement method with the relative delay information and the position information of the base stations 202, 204, and 206. At this time, the PDE 400 requires at least two pieces of relative delay information to measure the position of the terminal 100. The relative delay information includes information indicating the relative delay information of the base stations.

After calculating the position of the terminal 100, the PDE 400 may transmit the calculated position to the main base station 202 and/or the terminal 100 to allow the main base station 202 and/or the terminal 100 to know the position of the terminal 100, if necessary. The main base station 202 may use the calculated position to be synchronized with the terminal 100 when a hand-over is required for the terminal 100.

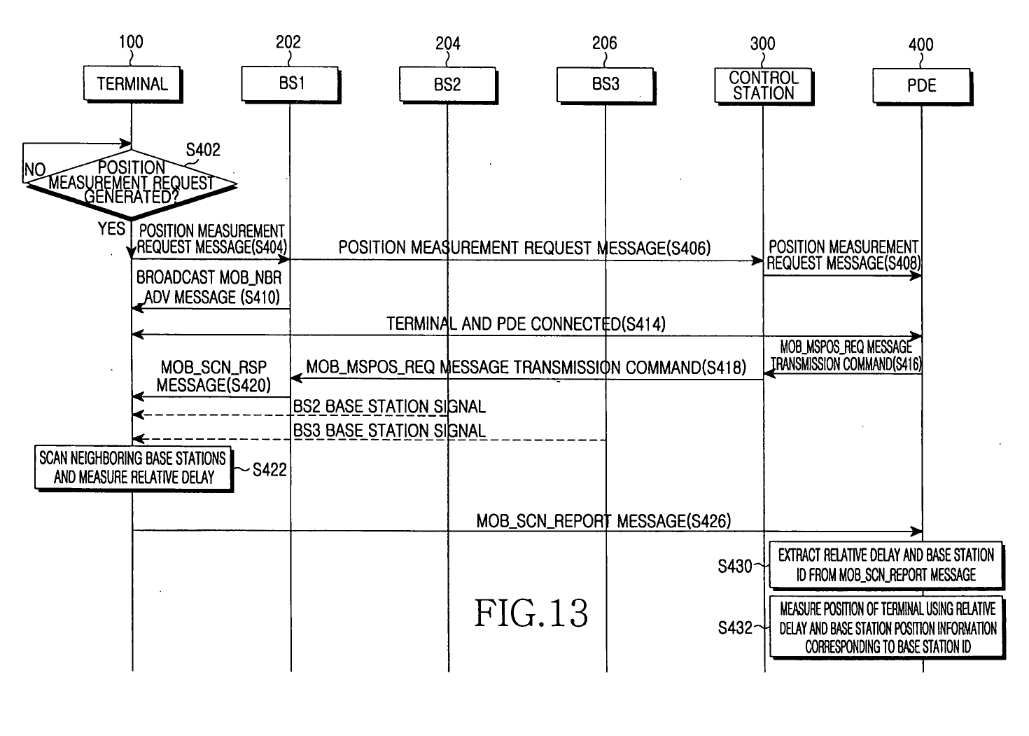

Although the terminal 100 transmits both the position measurement request and the neighboring base station scan result to the PDE 400 using a WiBro network shown in FIG. 4, the terminal 100 may transmit the position measurement request using the WiBro network and transmit the neighboring base station scan result directly to the PDE 400 using a TCP/IP network without having to be transmitted via the main base station 202 and the control station 300 as illustrated in FIG. 13.

FIG. 13 is a flowchart illustrating a position measuring method using relative delay information according to a sixth embodiment of the present invention.

In FIG. 13, after the position measurement request is generated in steps S402 through S408, the terminal 100 receives the MOB_NBR_ADV message in step S410 and transmits the MOB_SCN_REPORT message including the scan result directly to the PDE 400 in step S426. The remaining operations in FIG. 13 are the same as those in FIG. 4, and will not be further described herein.

According to another embodiment of the present invention, the terminal 100 may directly measure its position using the relative delay information for the neighboring base stations 204 and 206 and position information of the base stations 202, 204, and 206. In other words, the terminal 100 may calculate its position using its measurement value if it determines its position.

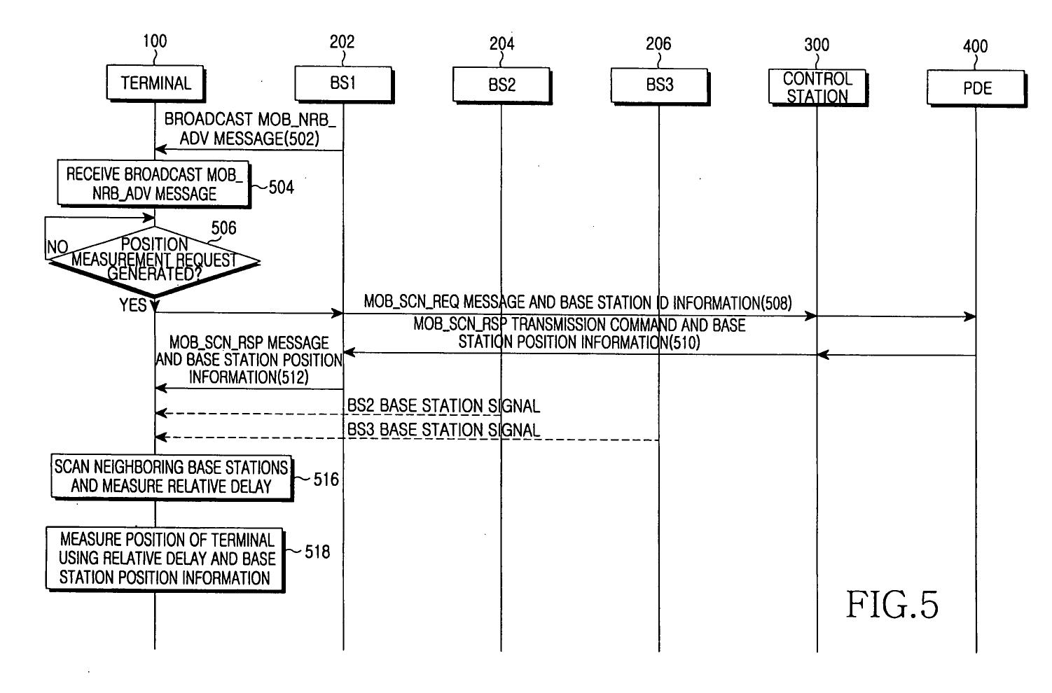

FIG. 5 is a flowchart illustrating a position measuring method using relative delay information according to a second embodiment of the present invention. Referring to FIG. 5, the main base station 202 broadcasts the MOB_NBR_ADV message including information about its neighboring base stations 204 and 206 in step 502. At this time, the MOB_NBR_ADV message may be used for a position measurement request generated by a need to measure the position of the terminal 100 or a need for the main base station 202 to secure a measurement value required for measuring the position of the terminal 100.

The terminal 100 receives the MOB_NBR_ADV message from the main base station 202 in step 504. The terminal 100 may acquire information about its neighboring base stations 204 and 206 (e.g., the IDs of the neighboring base stations 204 and 206) from the received MOB_NBR_ADV message.

After receipt of the MOB_NBR_ADV message, the terminal 100 determines whether a position measurement request is generated in step 506. The position measurement request may be generated by a need for the terminal 100 to check its position or a need for the main base station 202 to measure the position of the terminal 100.

If the position measurement request is generated, the terminal 100 transmits the MOB_SCN_REQ message for requesting neighboring base station scan information and base station ID information for requesting position information of the base stations 202, 204, and 206 to the PDE 400 through the main base station 202 and the control station 300 in step 508. At this time, the main base station 202 transmits the MOB_SCN_REQ message and base station ID information received from the terminal 100 to the control station 300. The control station 300 transmits the MOB_SCN_REQ message and the base station ID information received from the base station 202 to the PDE 400. Upon receipt of the MOB_SCN_REQ message and the base station ID information, the main base station 202, the control station 300, and the PDE 400 recognize that the neighboring base station scan information and position information of the base stations 202, 204, and 206 are requested from the terminal 100.

Upon receipt of the MOB_SCN_REQ message and the base station ID information, the PDE 400 transmits in step 510 the MOB_SCN_RSP transmission command and the position information of the base stations 202, 204, and 206 corresponding to the base station ID information to the main bas station 202 through the control station 300. At this time, the PDE 400 also transmits BS Almanac information including the time and position of each base station when transmitting the position information of each of the base stations 202, 204, and 206.

Upon receipt of the MOB_SCN_RSP transmission command and the position information of the base stations 202, 204, and 206, the main base station 202 transmits in step 512 the MOB_SCN_RSP message and the position information to the terminal 100. At this time, the MOB_SCN_RSP message is information for scanning the neighboring base stations 204 and 206 and includes time required for scanning the neighboring base stations 204 and 206, the number of scan operations, and a scan result reporting mode. The detailed structure of the MOB_SCN_RSP message has already been described with reference to FIG. 11.

The terminal 100 receives the MOB_SCN_RSP message and the position information of the base stations 202, 204, and 206 corresponding to the base station ID information, and scans in step 516 the neighboring base stations 204 and 206 according to the neighboring base station scan information included in the MOB_SCN_RSP message and measures relative delays for the neighboring base stations 204 and 206.

For example, the terminal 100 receives the BS2 base station signal and the BS3 base station signal according to the neighboring base station scan information, scans the neighboring base stations 204 and 206, and measures the relative delay information for the neighboring base stations 204 and 206 with respect to the main base station 202.

The terminal 100 measures its position using the relative delay information and the position information of the base stations 202, 204, and 206 corresponding to the base station ID information in step 518. In other words, the terminal 100 acquires a difference between a distance between the terminal 100 and the neighboring base station 204, and a distance between the terminal 100 and the neighboring base station 206, using the relative delay information, and measures its position using a trigonometric measurement method with the relative delay information and the position information of the base stations 202, 204, and 206.

In the previous embodiment of the present invention, the PDE 400 provides the position information of the base stations 202, 204, and 206 only to a specific terminal.

However, according to yet another embodiment of the present invention, the main base station 202 may broadcast its position information and position information of the neighboring base stations 204 and 206 to all terminals within a corresponding cell through cell broadcasting.

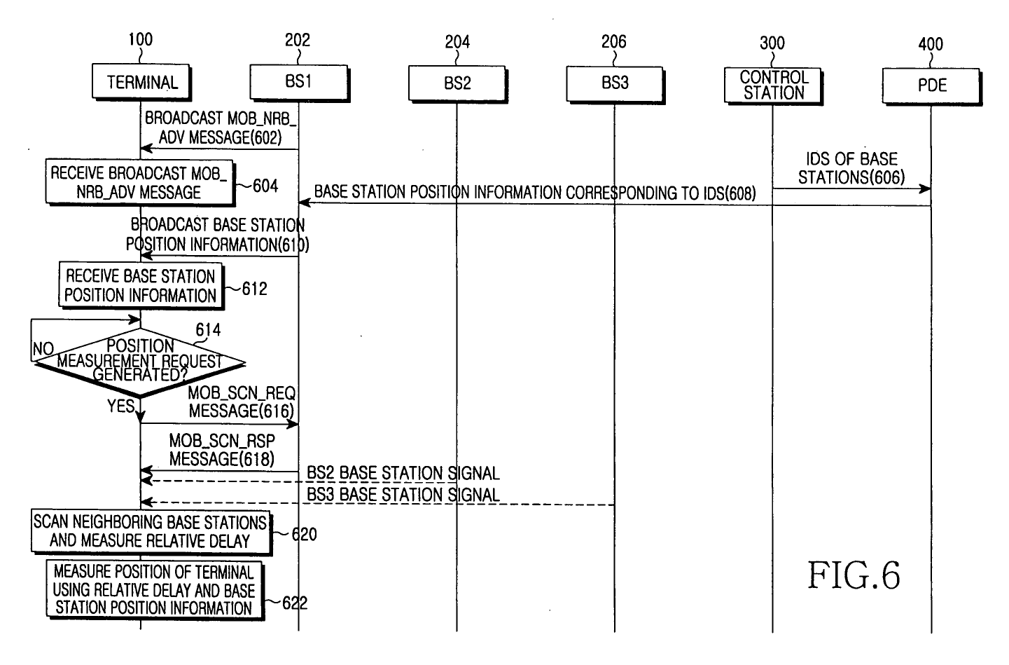

FIG. 6 is a flowchart illustrating a position measuring method using relative delay information according to a third embodiment of the present invention. Referring to FIG. 6, the main base station 202 broadcasts the MOB_NBR_ADV message including information about its neighboring base stations 204 and 206 in step 602.

The terminal 100 then receives the MOB_NBR_ADV message from the main base station 202 in step 604. The terminal 100 may acquire information about its neighboring base stations 204 and 206 (e.g., the IDs of the neighboring base stations 204 and 206) from the received MOB_NBR_ADV message.

The control station 300 knows the IDs of base stations 202, 204, and 206 and provides the IDs to the PDE 400 in step 606.

Upon receipt of the IDs from the control station 300, the PDE 400 transmits in step 608 position information of the base stations 202, 204, and 206 corresponding to the IDs to the main base station 202.

The main base station 202 receives the position information of the base stations 202, 204, and 206 corresponding to the IDs from the PDE 400 and broadcasts the received position information to a corresponding cell in step 610.

The terminal 100 receives the position information in step 612.

Upon receipt of the position information, the terminal 100 determines whether the position measurement request is generated in step 614. The position measurement request is generated by a need for the terminal 100 to check its position or a need for the main base station 202 to measure the position of the terminal 100.

If the position measurement request is generated, the terminal 100 transmits the MOB_SCN_REQ message for requesting neighboring base station scan information to the main base station 202 in step 616. The detailed structure of the MOB_SCN_REQ message is already described with reference to FIG. 10.

Upon receipt of the MOB_SCN_REQ message, the main base station 202 transmits the MOB_SCN_RSP message to the terminal 100 in step 618. At this time, the MOB_SCN_RSP message is information for scanning the neighboring base stations 204 and 206 and includes time required for scanning the neighboring base stations 204 and 206, the number of scan operations, and a scan result reporting mode. The detailed structure of the MOB_SCN_RSP message is already described with reference to FIG. 11.

Upon receipt of the MOB_SCN_RSP message from the main base station 202, the terminal 100 scans the neighboring base stations 204 and 206 according to the neighboring base station scan information included in the MOB_SCN_RSP message and measures relative delays for the neighboring base stations 204 and 206 in step 620. For example, the terminal 100 receives the BS2 base station signal and the BS3 base station signal according to the neighboring base station scan information, scans the neighboring base stations 204 and 206, and measures the relative delay information for the neighboring base stations 204 and 206 with respect to the main base station 202.

The terminal 100 in step 622 then measures its position using the relative delay information and the position information of the base stations 202, 204, and 206 corresponding to the base station ID information.

According to still another embodiment of the present invention, the position of the terminal 100 may be measured according to the position measurement request message transmitted to the terminal 100 and the main base station 202 by the PDE 400 when the PDE 400 needs to measure the position of the terminal 100.

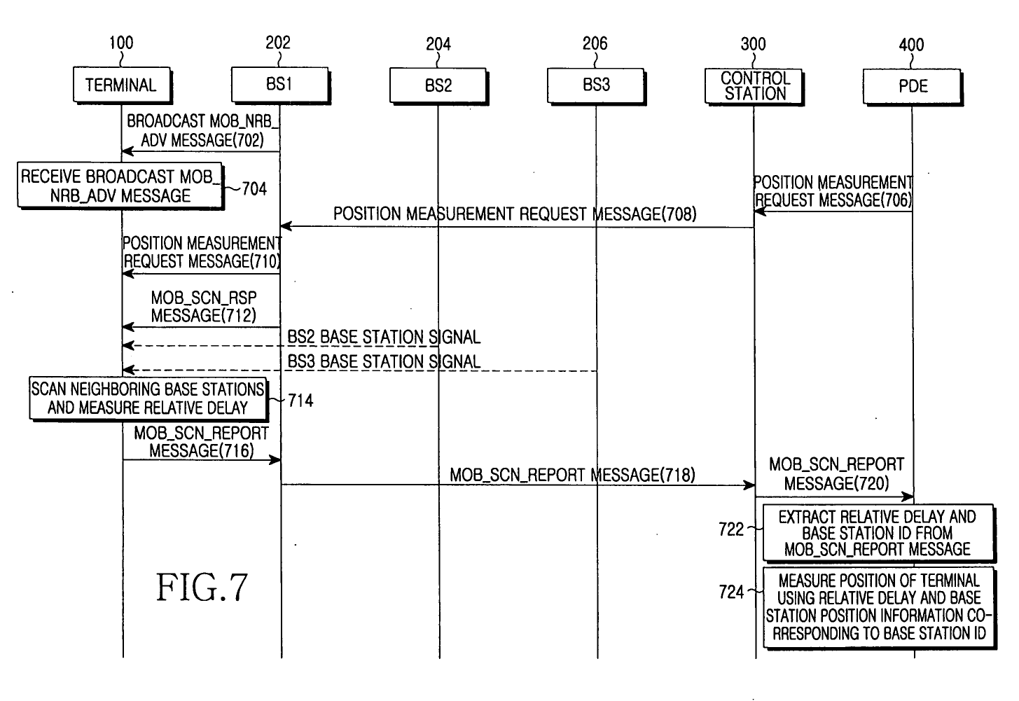

FIG. 7 is a flowchart illustrating a position measuring method using relative delay information according to a fourth embodiment of the present invention. In FIG. 7, the PDE 400 requests position measurement, and a position measurement request from the PDE 400 is transmitted to the terminal 100 via the control station 300 and the main base station 202 using a WiBro network and a neighboring base station scan result from the terminal 100 is transmitted to the PDE 400 via the control station 300 and the main base station 202 using the WiBro network.

First, position measurement for the terminal 100 begins with the transmission of a position measurement request message from the PDE 400. To this end, the PDE 400 transmits the position measurement request (MOB_MSPOS_REQ) message to the control station 300 in step 706 if a position measurement of the terminal 100 is needed. At this time, the MOB_MSPOS_REQ message includes information indicating that the position measurement request for the terminal 100 is generated and information for causing the main base station 202 to transmit the MOB_SCN_RSP message to the terminal 100.

The controls station 300 transmits the MOB_MSPOS_REQ message from the PDE 400 to the main base station 202 in step 708.

The main base station 202 transmits the received MOB_MSPOS_REQ message to the terminal 100 in step 710 and periodically broadcasts the MOB_NBR_ADV message including information about its neighboring base stations 204 and 206 in step 711. Thus, the receipt of the MOB_NBR_ADV message is passively performed in view of the terminal 100 and may precede the transmission of the MOB_MSPOS_REQ message. At this time, the MOB_NBR_ADV message may be used when the position measurement request is generated by a need to measure the position of the terminal 100 or a need for the main base station 202 to secure a measurement value required for measuring the position of the terminal 100. The main base station 202 transmits the MOB_SCN_RSP message to the terminal 100 in step 712 after changing a specific field value of the MOB_SCN_RSP message to indicate that the MOB_SCN_RSP message is intended for position measurement, as described with reference to FIG. 11.

Upon receipt of the position measurement request message from the main base station 202, the terminal 100 can recognize that the position measurement request message for requesting measurement of its position is generated from the PDE 400 and scan its neighboring base stations 204 and 206 required for the measurement using the MOB_SCN_RSP message transmitted from the main base station 202.

Upon receipt of the position measurement request message, the MOB_NBR_ADV message, and the MOB_SCN_RSP message from the main base station 202, the terminal 100 scans in step 714 the neighboring base stations 204 and 206 according to information included in the MOB_NBR_ADV message and the MOB_SCN_RSP message and measures relative delay information for the neighboring base stations 204 and 206 according to the scan result in step 714. For example, the terminal 100 scans the neighboring base stations 204 and 206 by receiving the BS2 base station signal from the neighboring base station 204 and the BS3 base station signal from the neighboring base station 206 according to the information included in the MOB_SCN_RSP message and measures the relative delay information for the neighboring base stations 204 and 206 according to the scan result.

The terminal 100 encapsulates the neighboring base station scan result and the relative delay information in the MOB_SCN_REPORT message and transmits the MOB_SCN_REPORT message to the main base station 202 in step 716.

Upon receipt of the MOB_SCN_REPORT message from the terminal 100 in step 716, the main base station 202 transmits in step 718 the received MOB_SCN_REPORT message to the controls station 300.

The control station 300 receives the MOB_SCN_REPORT message from the main base station 202 and then transmits the received MOB_SCN_REPORT message to the PDE 400 in step 720.

The PDE 400 receives the MOB_SCN_REPORT message from the control station 300, extracts in step 722 the relative delay information and the base station ID information, and measures in step 724 the position of the terminal 100 using the relative delay information and the position information of the base stations 202, 204, and 206 corresponding to the base station ID information. For example, the PDE 400 acquires a difference between a distance between the terminal 100 and the neighboring base station 204, and a distance between the terminal 100 and the neighboring base station 206, using the relative delay information, and measures the position of the terminal 100 using a trigonometric measurement method with the relative delay information and the position information of the base stations 202, 204, and 206.

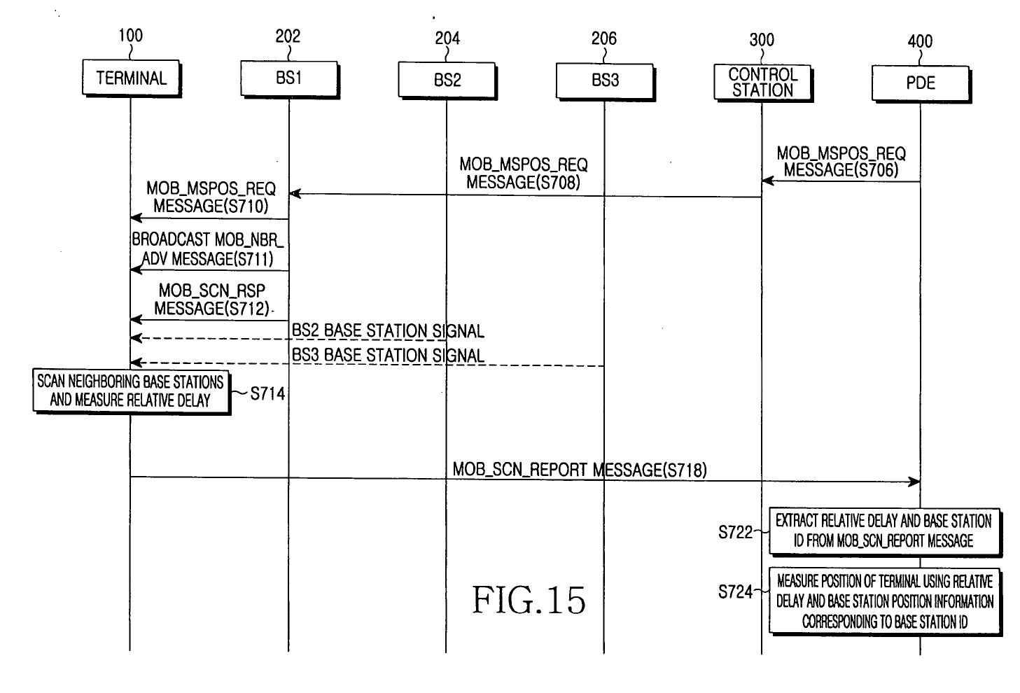

Unlike in FIG. 7, the PDE 400 may transmit the position measurement request to the terminal 100 using the WiBro network and the terminal 100 may transmit the neighboring base station scan result directly to the PDE 400 using a TCP/IP network as illustrated in FIG. 15. Referring to FIG. 15, the MOB_SCN_REPORT message including the neighboring base station scan result is directly to the PDE 400 from the terminal 100 in step S718. FIG. 15 is a flowchart illustrating a position measuring method using relative delay information according to an eighth embodiment of the present invention. Steps S706 through S714 of FIG. 15 are the same as steps 706 through 714 of FIG. 7 and steps S722 and S724 are similar to steps S722 and S724.

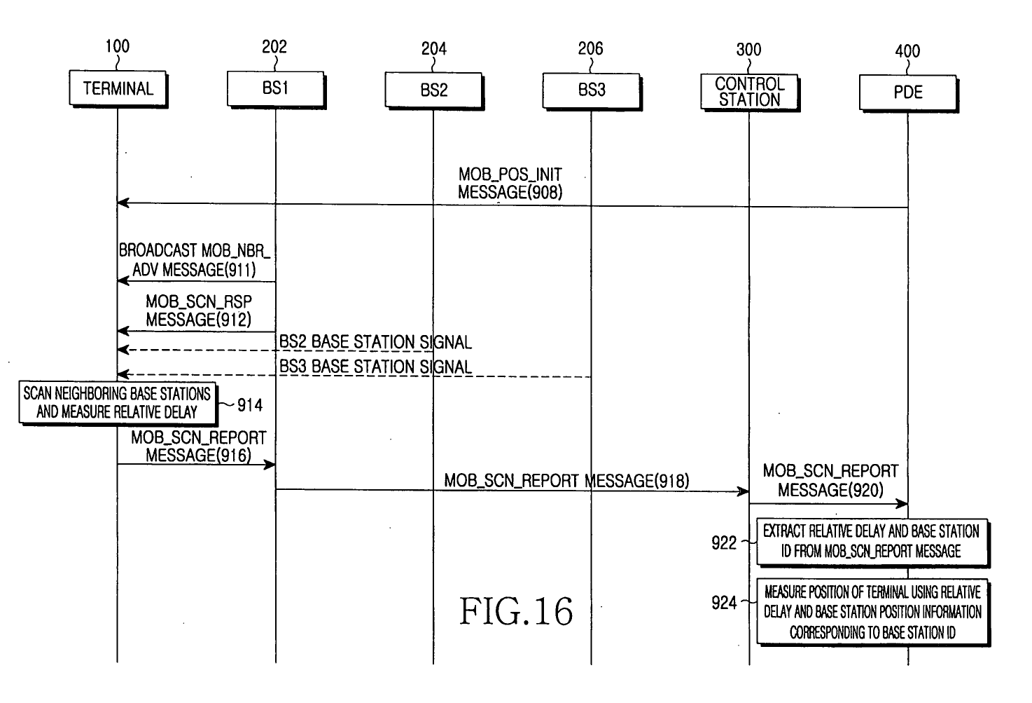

Unlike in FIG. 7, the PDE 400 may transmit the position measurement request to the terminal 100 using a TCP/IP network and the terminal 100 may transmit the neighboring base station scan result to the PDE 400 using a WiBro network via the main base station 202 and the control station 300, as illustrated in FIG. 16. Referring to FIG. 16, a position measurement request (MOB_POS_INIT) message is transmitted directly to the terminal 100 from the PDE 400 using a TCP/IP network in step S908. FIG. 16 is a flowchart illustrating a position measuring method using relative delay information according to a ninth embodiment of the present invention. Steps 911 through 924 of FIG. 16 are the same as steps 711 through 724 of FIG. 7, respectively, and will not be further described herein.

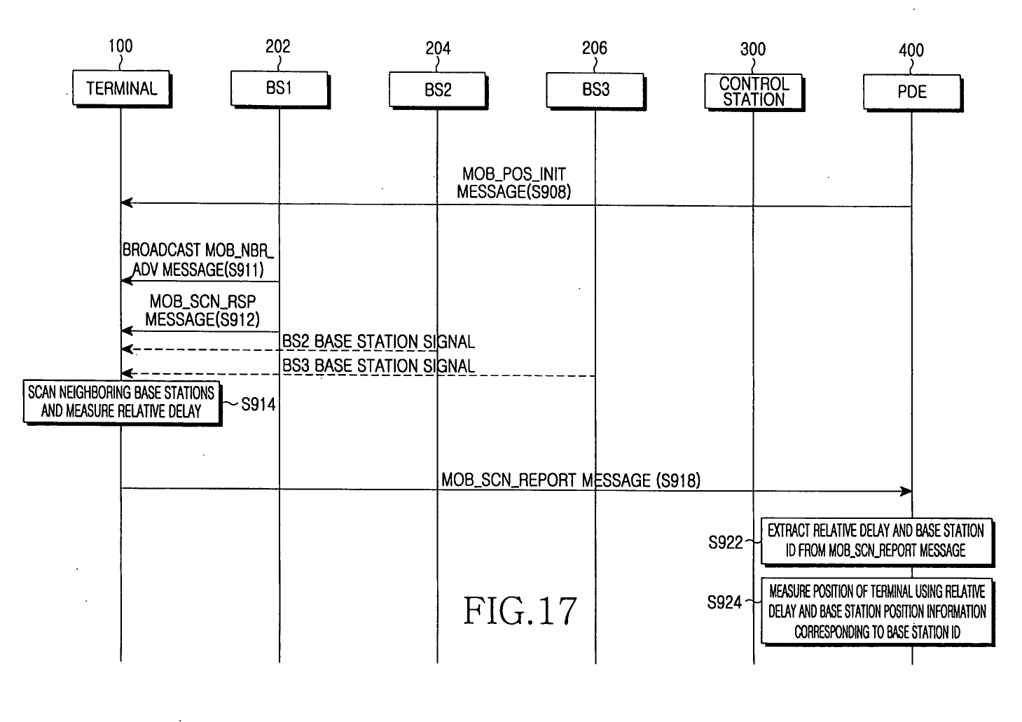

The PDE 400 may transmit the position measurement request to the terminal 100 using a TCP/IP network and the terminal 100 may transmit the neighboring base station scan result to the PDE 400 using the TCP/IP network, as illustrated in FIG. 17. FIG. 17 is a flowchart illustrating a position measuring method using relative delay information according to a tenth embodiment of the present invention. Steps S908 through S914 of FIG. 17 are the same as steps 908 through S914 of FIG. 16 and steps S918 through S924 of FIG. 17 are the same as steps S718 through S724 of FIG. 15, respectively.

According to still another embodiment of the present invention, the terminal 100 may transmit the position measurement request message to the PDE 400 using Internet Protocol (IP).

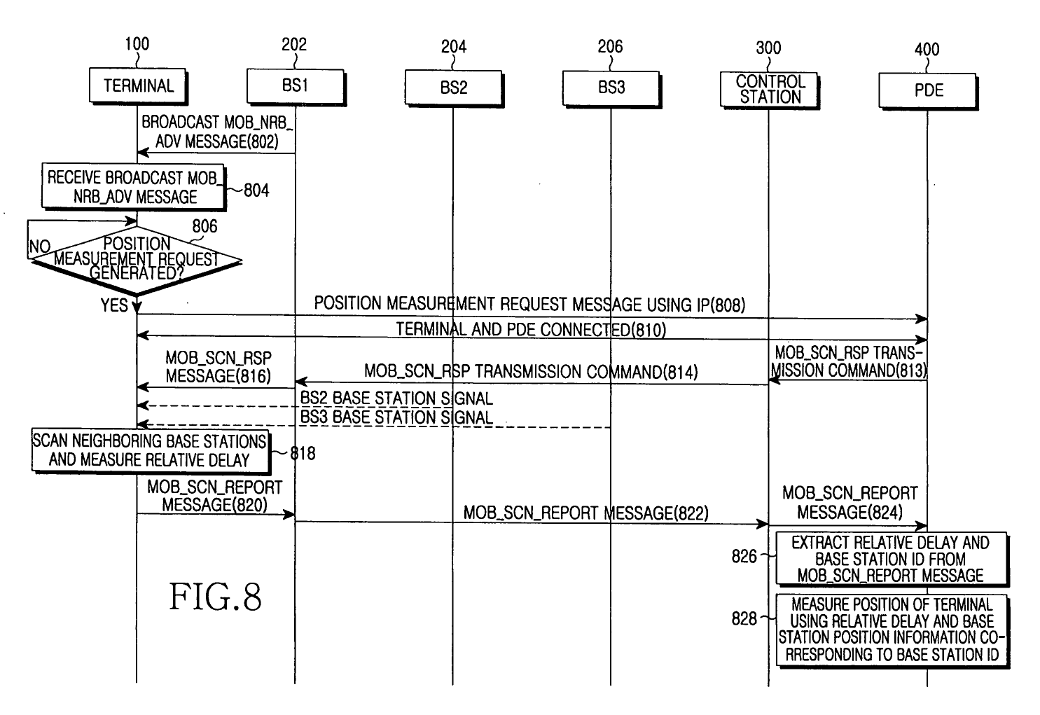

FIG. 8 is a flowchart illustrating a position measuring method using relative delay information according to a fifth embodiment of the present invention. In FIG. 8, the terminal 100 request position measurement, and the position measurement request from the terminal 100 is transmitted directly to the PDE 400 using a TCP/IP network and the neighboring base station scan result is transmitted from the terminal 100 to the PDE 400 via the main base station 202 and the control station 300 using a WiBro network.

Referring to FIG. 8, the MOB_NBR_ADV message is periodically broadcast by the main base station 202 in step 802. After receipt of the MOB_NBR_ADV message in step 804 and determining in step 806 of the position measurement request has been generated, the terminal 100 transmits the position measurement request message to the PDE 400 using IP in step 808 if it determines that it is necessary to measure its position. Steps 810 through 828 are then performed to measure the position of the terminal 100. Since steps 810 through 828 of FIG. 8 are the same as steps 414 through 432 of FIG. 4, they will not be further described herein.

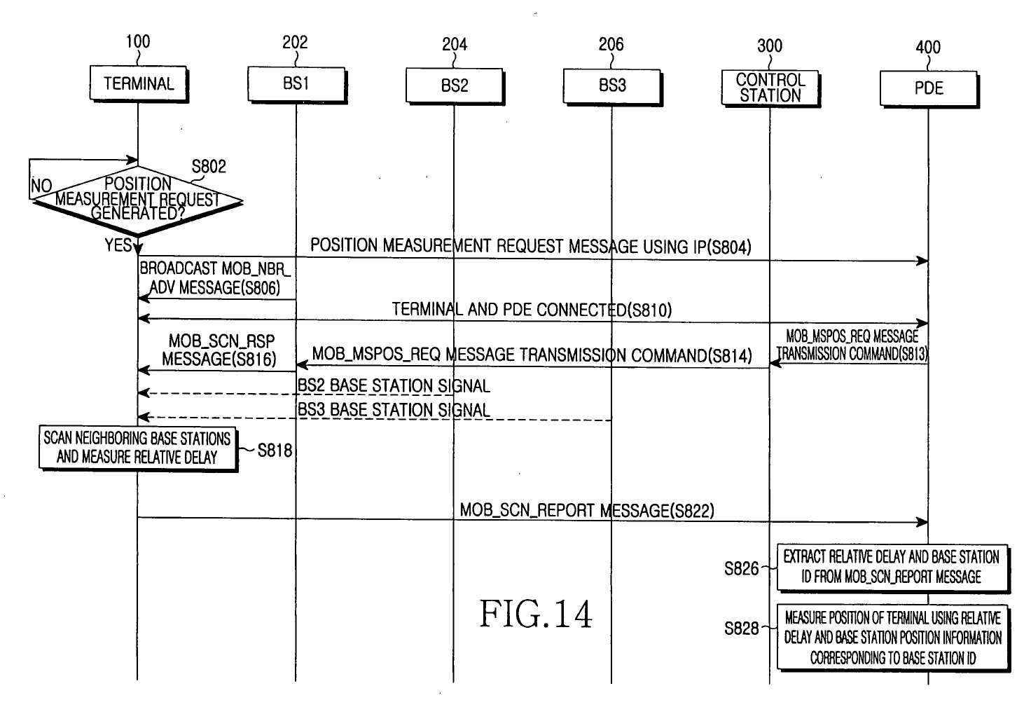

FIG. 14 is a flowchart illustrating a position measuring method using relative delay information according to a seventh embodiment of the present invention. In FIG. 14, the terminal 100 requests position measurement, and both the position measurement request and the neighboring base station result from the terminal 100 are transmitted directly to the PDE 400 using a TCP/IP network. Thus, referring to FIG. 14, if the position measurement request is generated in step S802, a position measurement request (MOB_POS_START) message is transmitted to the PDE 400 in step S804. The MOB_NBR_ADV message is received in step S806 and the MOB_SCN_REPORT message is transmitted from the terminal 100 directly to the PDE 400 in step S822. The remaining operations in FIG. 14 are the same as those in FIG. 8 and will not be further described herein.

As described above, according to the present invention, by using relative delay information of a conventional WiBro system, position measurement can be easily performed.

Moreover, since the position of a terminal is measured using a parameter used for a hand-over, additional data measurement is not required for the position measurement.

Furthermore, efficiency in the use of a parameter of a WiBro system can be improved by using a parameter previously used only in a hand-over for position measurement.

While the present invention has been shown and described with reference to preferred embodiments thereof, it will be understood by those skilled in the art that various changes in form and details may be made therein without departing from the spirit and scope of the invention.

What is claimed is:

1. A position measuring system using a Wireless Broadband (WiBro) signal, comprising:
a main base station for providing information about neighboring base stations and transmitting a neighboring base station scan result;
a terminal for receiving the information about the neighboring base stations, scanning the neighboring base stations in response to a position measurement request, and transmitting the neighboring base station scan result to the main base station; and
a Position Determination Entity (PDE) for measuring the position of the terminal using relative delay information between the main base station and the neighboring base stations, which is included in the neighboring base station scan result from the main base station, and base station position information.

2. The position measuring system of claim 1, wherein there are at least two pieces of relative delay information.

3. The position measuring system of claim 1, wherein the PDE measures the position of the terminal using a distance difference between the terminal and the neighboring base stations, acquired using the relative delay information and the base station position information.

4. The position measuring system of claim 1, wherein the PDE stores the base station position information corresponding to base station ID information.

5. The position measuring system of claim 3, wherein the PDE extracts the relative delay information and base station ID information from the neighboring base station scan result.

6. The position measuring system of claim 5, wherein the PDE measures the position of the terminal using the relative delay information and base station position information corresponding to the base station ID information.

7. The position measuring system of claim 1, wherein the PDE measures the position of the terminal using a trigonometric measurement method.

8. The position measuring system of claim 1, further comprising a control station located between the main base station and the PDE for receiving the neighboring base station scan result from the main base station and providing the neighboring base station scan result to the PDE.

9. The position measuring system of claim 1, wherein the terminal transmits a position measurement request message including a neighboring base station scan information request to the main base station in response to the position measurement request, receives the neighboring base station scan information from the main base station, and scans the neighboring base stations.

10. The position measuring system of claim 1, wherein the terminal communicates with the PDE using an Internet Protocol (IP).

11. The position measuring system of claim 1, wherein the PDE provides to the terminal a position measurement request message including neighboring base station scan information through the main base station in response to the position measurement request to cause the terminal to scan the neighboring base stations.

12. A position measuring system using a Wireless Broadband (WiBro) signal, comprising:
a Position Determination Entity (PDE) for providing base station position information;
a main base station for providing information about neighboring base stations; and
a terminal for scanning the neighboring base stations in response to a position measurement request, measuring relative delay information between the main base station and the neighboring base stations, and measuring the position of the terminal using the relative delay information and the base station position information provided from the PDE.

13. The position measuring system of claim 12, wherein there are at least two pieces of relative delay information.

14. The position measuring system of claim 12, wherein the terminal calculates a distance difference between the terminal and the neighboring base stations, using the relative delay information, and measures its position using the calculated distance difference and the base station position information.

15. The position measuring system of claim 12, wherein the PDE provides the base station position information corresponding to base station ID information transmitted from the terminal.

16. The position measuring system of claim 12, wherein the PDE broadcasts the base station position information corresponding to base station ID information through the main base station.

17. The position measuring system of claim 15, further comprising a control station for providing the base station ID information to the PDE.

18. A position measuring method using a Wireless Broadband (WiBro) signal, comprising the steps of:
providing by a main base station to a terminal information about neighboring base stations;
scanning by the terminal the neighboring base stations and transmitting by the terminal a neighboring base station scan result to a Position Determination Entity (PDE); and
measuring by the PDE the position of the terminal using relative delay information between the main base station and the neighboring base stations, which is included in the neighboring base station scan result, and previously stored base station position information.

19. The position measuring method of claim 18, wherein there are at least two pieces of relative delay information.

20. The position measuring method of claim 18, wherein the PDE measures the position of the terminal using a distance difference between the terminal and the neighboring base stations acquired using the relative delay information and the base station position information.

21. The position measuring method of claim 20, wherein the step of measuring the position of the terminal using the distance difference uses a trigonometric measurement method.

22. The position measuring method of claim 18, wherein the step of scanning the neighboring base stations comprises the steps of:
transmitting by the terminal a position measurement request message including a neighboring base station scan information request to the PDE in response to the position measurement request;
commanding by the PDE the main base station to provide the neighboring base station scan information to the terminal upon receipt of the position measurement request message;
providing by the main base station the neighboring base station scan information to the terminal; and
receiving by the terminal the neighboring base station scan information from the main base station and scanning the neighboring base stations.

23. The position measuring method of claim 18, wherein the terminal communicates with the PDE using Internet Protocol (IP).

24. The position measuring method of claim 18, wherein the step of scanning the neighboring base stations comprises the steps of:
transmitting by the PDE a position measurement request message to cause the main base station to provide the neighboring base station scan information to the terminal in response to the position measurement request;
providing by the main base station the neighboring base station scan information to the terminal; and
scanning by the terminal the neighboring base stations using the neighboring base station scan information transmitted from the main base station.

25. The position measuring method of claim 18, further comprising the step of receiving by a control station located between the main base station and the PDE the neighboring base station scan result from the main base station and providing by the control station the received neighboring base station scan result to the PDE.

26. The position measuring method of claim 18, wherein the step of measuring the position of the terminal comprises the steps of:
receiving by the PDE the neighboring base station scan result of the terminal;
extracting relative delay information between the main base station and the neighboring base stations, which is included in the received neighboring base station scan result, and base station ID information; and
measuring the position of the terminal using the extracted relative delay information and the base station position information corresponding to the base station ID information.

27. A position measuring method using a Wireless Broadband (WiBro) signal, comprising the steps of:
receiving by a terminal information about neighboring base stations from a main base station;
providing to the terminal base station position information from a Position Determination Entity (PDE);
scanning by the terminal the neighboring base stations and measuring relative delay between the main base station and the neighboring base stations; and
measuring by the terminal its position using the relative delay information and the base station position information.

28. The position measuring method of claim 27, wherein there are at least two pieces of relative delay information.

29. The position measuring method of claim 27, wherein the terminal calculates a distance difference between itself and the neighboring base stations using the relative delay information and measures its position using the calculated distance difference the base station position information.

30. The position measuring method of claim 29, wherein the measurement of the position of the terminal using the distance difference uses a trigonometric measurement method.

31. The position measuring method of claim 27, wherein the step of being provided with the base station position information comprises the steps of:
transmitting by the terminal IDs of the main base station and the neighboring base stations to the PDE in response to a position measurement request; and
providing to the terminal base station position information corresponding to the base station ID information among previously stored base station position information from the PDE.

32. The position measuring method of claim 27, wherein the terminal communicates with the PDE using Internet Protocol (IP).

33. The position measuring method of claim 27, wherein the step of scanning the neighboring base stations comprises the steps of:
transmitting by the PDE a position measurement request message to the main base station to cause the main base station to provide neighboring base station scan information to the terminal;
providing by the main base station the neighboring base station scan information to the terminal; and
scanning by the terminal the neighboring base stations using the neighboring base station scan information received from the main base station.

34. A position measuring system using a Wireless Broadband (WiBro) signal, comprising:
a terminal for transmitting a position measurement request message in response to a position measurement request, scanning neighboring base stations, and transmitting a neighboring base station scan result; and
a Position Determination Entity (PDE) for receiving the position measurement request message from the terminal and, upon receipt of a neighboring base station scan result, measuring the position of the terminal using the neighboring base station scan result.

35. The position measuring system of claim 34, wherein the terminal transmits the position measurement request message and the neighboring base station scan result to the PDE using one of the IP address of the PDE and a WiBro network.

36. The position measuring system of claim 35, wherein all messages from the terminal are transmitted directly to the PDE when the IP address of the PDE is used for the transmission.

37. The position measuring system of claim 34, wherein the position measurement request message is a MOB_SCN_REQ message in which a code value of a specific field is changed to indicate that the MOB_NBR_REQ message is intended for position measurement.

38. The position measuring system of claim 35, further comprising:
a base station for broadcasting a MOB_NBR_ADV message including information about the neighboring base stations and transmitting a MOB_SCN_RSP message to the terminal after incorporating in the MOB_SCN_RSP message information required for scanning the neighboring base stations in response to the position measurement request message; and
a control station for transmitting and receiving messages between the base station and the PDE.

39. The position measuring system of claim 38, wherein all messages from the terminal are transmitted to the PDE via the base station and the control station when the WiBro network is used for the transmission.

40. The position measuring system of claim 34, wherein the PDE measures the position of the terminal using relative delay information between the main base station and the neighboring base stations, which is included in the neighboring base station scan result, and base station position information.

41. The position measuring system of claim 38, wherein the terminal scans the neighboring base stations using information included in the MOB_NBR_ADV message and the MOB_SCN_RSP message.

42. The position measuring system of claim 38, wherein the base station transmits the MOB_SCN_RSP message after changing a code value of a specific field of the MOB_SCN_RSP message to indicate that the MOB_SCN_RSP message is intended for position measurement.

43. A position measuring system using a Wireless Broadband (WiBro) signal, comprising:
a Position Determination Entity (PDE) for transmitting a position measurement request message in response to a position measurement request; and
a terminal for scanning neighboring base stations upon receipt of the position measurement request message and transmitting a neighboring base station scan result,
wherein upon receipt of the neighboring base station scan result from the terminal, the PDE measures the position of the terminal using the neighboring base station scan result.

44. The position measuring system of claim 43, wherein the PDE transmits the position measurement request message to the terminal using one of the IP address of the terminal and a WiBro network.

45. The position measuring system of claim 44, wherein the PDE transmits the position measurement request message directly to the terminal when the IP address of the terminal is used for the transmission.

46. The position measuring system of claim 44, further comprising:
a base station for broadcasting a MOB_NBR_ADV message including information about the neighboring base stations and transmitting a MOB_SCN_RSP message to the terminal after incorporating in the MOB_SCN_RSP message information required for scanning the neighboring base stations in response to the position measurement request message; and
a control station for transmitting and receiving messages between the base station and the PDE.

47. The position measuring system of claim 46, wherein the neighboring base station scan result from the terminal is transmitted to the PDE via the base station and the control station when the WiBro network is used for the transmission.

48. The position measuring system of claim 43, wherein the neighboring base station scan result from the terminal is transmitted directly to the PDE when the IP address of the terminal is used for the transmission.

49. The position measuring system of claim 46, wherein the PDE transmits the position measurement request message to the terminal via the base station and the control station when using the WiBro network.

50. The position measuring system of claim 46, wherein the base station transmits the MOB_SCN_RSP message after changing a code value of a specific field of the MOB_SCN_RSP message to indicate that the MOB_SCN_RSP message is intended for position measurement.

51. A position measuring method using a Wireless Broadband (WiBro) signal, comprising the steps of:
scanning, by a terminal, neighboring base stations in response to a position measurement request and transmitting, by the terminal, a neighboring base station scan result; and
receiving by a Position Determination Entity (PDE) the position measurement request message from the terminal and, measuring by a Position Determination Entity (PDE) the position of the terminal using the received neighboring base station scan result.

52. The position measuring method of claim 51, further comprising:
transmitting by the terminal a position measurement request message to the PDE in response to the position measurement request; and
receiving by the terminal information about the neighboring base stations broadcasted from a base station and receiving by the terminal a response message including information required for scanning the neighboring base stations in response to the position measurement request message.

53. The position measuring method of claim 52, wherein the neighboring base stations are scanned using the broadcasted information and the response message, and the neighboring base station scan result includes relative delay information between the base station and the neighboring base stations.

54. The position measuring method of claim 52, further comprising the step of receiving by a control base station the neighboring base station scan result between the base station and the PDE received by the base station from the terminal, and providing by the control base station the received neighboring base station scan result to the PDE.

55. The position measuring method of claim 54, wherein all messages from the terminal are transmitted directly to the PDE when an IP address of the PDE is used for the transmission.

56. The position measuring method of claim 54, wherein all messages from the terminal are transmitted to the PDE via the base station and the control station when a WiBro network is used for the transmission.

57. The position measuring method of claim 52, wherein the response message is transmitted after a code value of its specific field is changed to indicate that it is intended for position measurement.
